(19) United States
(12) Patent Application Publication
(10) Pub. No.: US 2017/0161960 A1
(43) Pub. Date: Jun. 8, 2017

(54) THREE DIMENSIONAL PRINTING FOR CONSUMERS

(71) Applicant: Wal-Mart Stores, Inc., Bentonville, AR (US)

(72) Inventors: Donald R. High, Noel, MO (US); John P. Thompson, Bentonville, AR (US); Robert C. Taylor, Rogers, AR (US); Michael D. Atchley, Springdale, AR (US)

(21) Appl. No.: 15/368,309

(22) Filed: Dec. 2, 2016

Related U.S. Application Data
(60) Provisional application No. 62/263,511, filed on Dec. 4, 2015.

(51) Int. Cl. G06T 19/20; G06F 17/50; B33Y 10/00; G06T 17/00; B33Y 30/00; G05B 13/04; G06K 9/46

(52) U.S. Cl. CPC G06T 19/20; G05B 13/04; G06F 17/5004; G06K 9/46; G06T 17/00; B33Y 30/00; B33Y 10/00; G05B 2219/49023; G06T 2200/08; G06T 2200/04; G06T 2219/2016

(57) ABSTRACT

A scan of a space is performed to obtain a three-dimensional model. An entity, such as a user, pet, or other object may be scanned separately to obtain an entity model. The model of the space and the entity mode may be combined to obtain a combined model. Prior to combining, a reference feature may be identified in the model of the space. Based on a known size of the reference feature, a scale of the model of the space may be determined. A reference feature of the entity model is used to determine a scale of the entity mode. Using the scales of the model of the space and the entity model, the models are scaled prior to combining. The combined model may be 3D printed. The model may be divided into separate pieces prior to 3D printing, the separate pieces being fastened to one another after printing.

### CROSS-REFERENCE TO RELATED APPLICATION

This application claims the benefit of U.S. Provisional Application No. 62/263,511, filed Dec. 4, 2015, which is incorporated herein by reference in its entirety.

### BACKGROUND

Field of the Invention

This invention relates to systems and methods for facilitating three-dimensionally printing models of real and virtual objects.

Background of the Invention

Three-Dimensional (3D) printing typically involves the repeated deposition of material (e.g. plastic) at appropriate locations to build up the form of a three-dimensional object. Some 3D printers deposit plastic whereas others selectively harden a resin using an appropriate wavelength of light.

The systems and methods disclosed herein provide an improved approach for generating custom 3D models of a space including people and objects of a customer's choice.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a schematic block diagram of a network environment suitable for implementing embodiments of the invention;

FIG. 2 is a schematic block diagram of an example computing device suitable for implementing methods in accordance with embodiments of the invention;

FIGS. 3A and 3B are process flow diagrams of methods for performing scans in accordance with an embodiment of the invention;

FIGS. 4A and 4B are views indicating the detection of features for determining scale in accordance with an embodiment of the present invention;

FIG. 5 is a process flow diagram of a method for generating a combined model in accordance with an embodiment of the present invention;

FIG. 6 is a process flow diagram of a method for dividing a model into separate pieces in accordance with an embodiment of the present invention; and

FIG. 7 is an isometric view indicating the automated sectioning of a model in accordance with an embodiment of the present invention.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. In selected embodiments, a computer-readable medium may comprise any non-transitory medium that can contain, store, communicate, propagate, or transport the program for use by or in connection with the instruction execution system, apparatus, or device.

Computer program code for carrying out operations of the present invention may be written in any combination of one or more programming languages, including an object-oriented programming language such as Java, Smalltalk, C++, or the like and conventional procedural programming languages, such as the “C” programming language or similar programming languages. The program code may execute entirely on a computer system as a stand-alone software package, on a stand-alone hardware unit, partly on a remote computer spaced some distance from the computer, or entirely on a remote computer or server. In the latter scenario, the remote computer may be connected to the computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a non-transitory computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

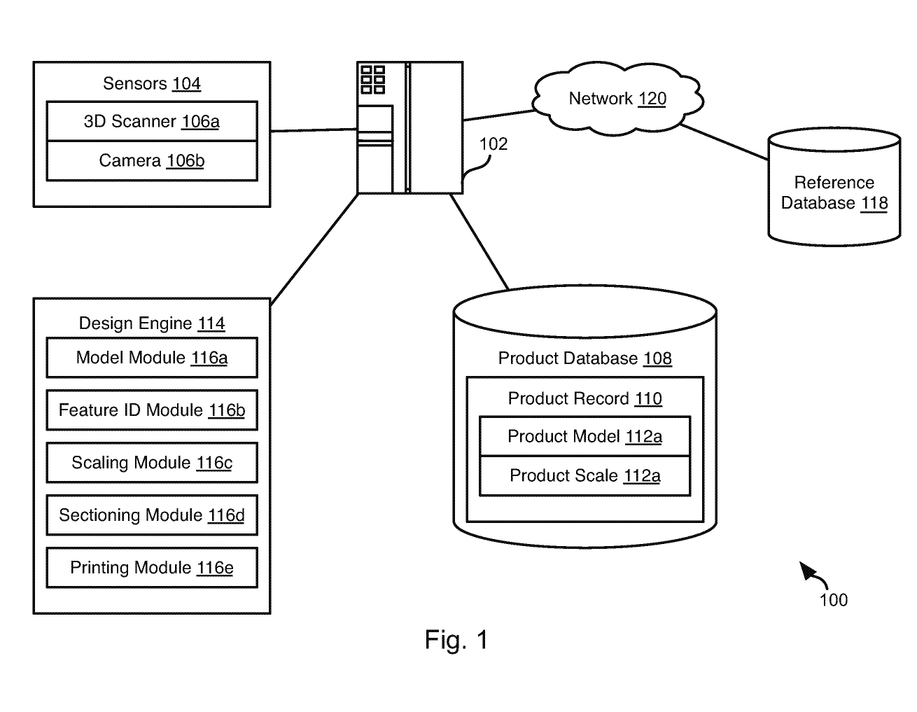

Referring to FIG. 1, a network environment 100 for implementing the systems and methods disclosed herein may include some or all of the illustrated components. As described in greater detail herein. The environment 100 may be used to facilitate the making of design choices and to enable the visualization of design choices in an existing space. To that end, the server system 102 may receive data from one or more sensors 104.

The sensors 104 may include one or more three-dimensional (3D) scanners 106a. The scanners 106a may include any three-dimensional scanner known in the art. For example, the scanners 106a may include the FARO FOCUS 3D laser scanner or other type of laser scanner. The scanners 106 may include an optical scanner such as the FARO FREESTYLE3D SCANNER or some other optical 3D scanner known in the art. In some embodiments, the 3D scanner 106a may be mounted to an unmanned aerial vehicle (e.g. quad copter or other drone) that is programmed to fly with the scanner around an interior or exterior space in order to perform a scan. In some embodiments, rather than performing scanning, 3D data of a lower quality may be inferred from 2D images or video data.

The sensors 104 may include a video camera 106b. In some embodiments, a field of view of the 3D scanner 106a may be simultaneously captured with the video camera 106b during scanning. The image data from the video camera may then be overlaid on a point cloud obtained from the scanner 106a to obtain a full color model of the area scanned. The manner in which the point cloud and image data are combined may include any technique known in the art.

The server system 102 may select products and treatments from a product database 108 as potential design elements for a space scanned using the sensors 104. The product database 108 may include a plurality of product records 110 for a plurality of products or treatments available from one or more retailers.

The product record 110 may include a product model 112a. The product model 112a may be a set of triangles with vertices defined by three-dimensional coordinates, definitions of shapes (spheres, rectangles, etc.) in three dimensions or other data sufficient to define the outer surface of a product. The product model 112a may be a full color model such that each element of the surface of the model has both a position and a color associated therewith. The product model 112a may include coordinates in a real scale such that a relative difference in coordinates between two points on the model correspond to an actual distance between those two points on an actual unit of the product. In other cases, the product database 108 may include a product scale 112b indicating a mapping between the coordinate space of the model and real dimensions.

The server system 102 may host or access a design engine 114. The design engine 114 may include a model module 116a. The model module 116a may generate a model from a point cloud from a 3D scanner 106a and image data from the camera 112a. The model module 116a may combine these to define a full color model of a room that has been scanned. The model module 116a may perform a filtering function, i.e. cleaning up of a model to remove extraneous objects resulting from the scanning and removing objects in the scan.

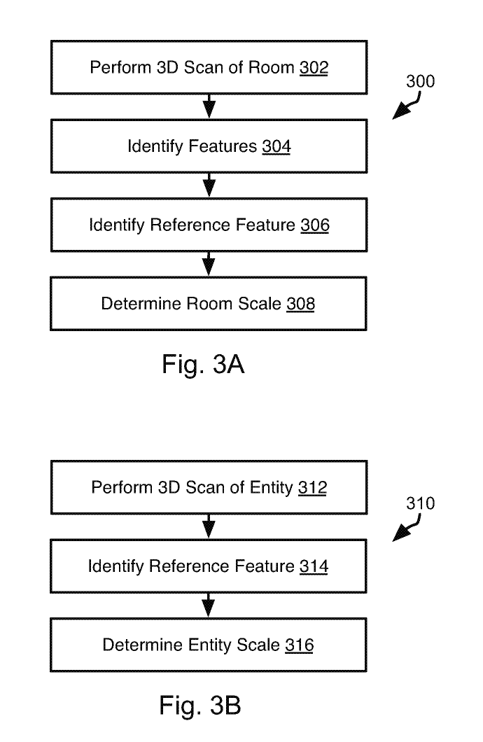

The design engine 114 may include a feature identification module 116b. As described in greater detail below, a scale of a space or entity scanned may be determined by detecting features of known dimensions in the three-dimensional data obtained from the scan. Accordingly such features may be identified using the feature identification module 116b as described below (see FIGS. 3A and 3B).

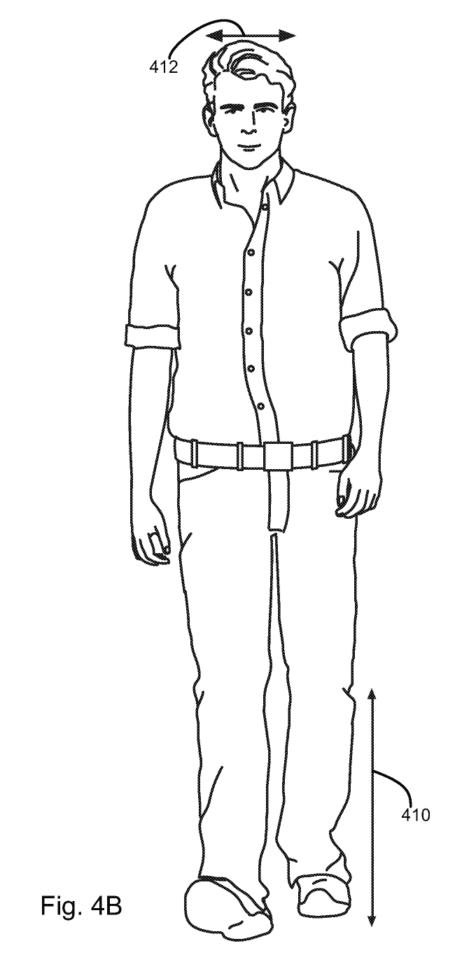

The design engine 114 may include a scaling module 116c. As discussed in greater detail, models scanned by separate scanners and/or at separate times may be combined. Likewise, recorded models of objects may be added to a model of a room. Accordingly, the scaling module 116c may scale one or both of the model of the room and the models of an entity or object to be added to the room such that they correspond to one another as discussed in greater detail with respect to FIG. 5.

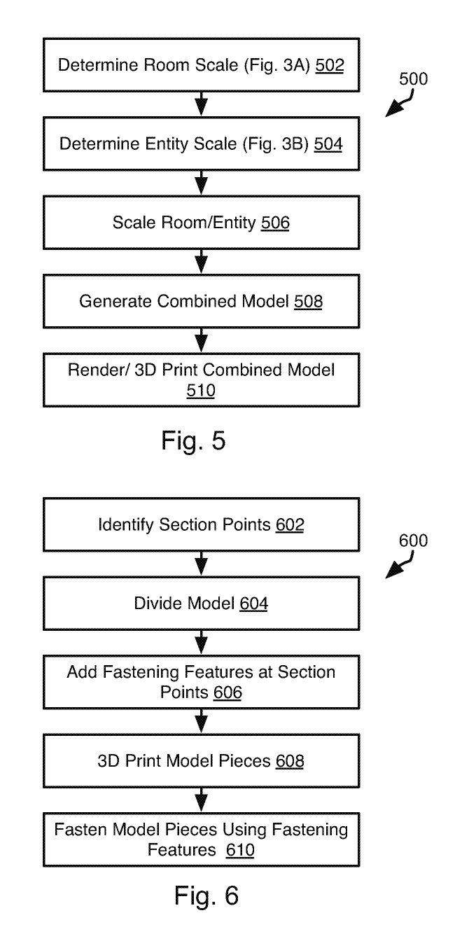

The design engine 114 may include a sectioning module 116d. In some embodiments, a room may be divided into pieces that are 3D printed separately and joined together. Likewise, one or more objects added to the model of a room may be divided into 3D printed as pieces or may be 3D printed as a separate piece from the one or more pieces of the room. Accordingly, the sectioning module 116d may section a combined model of a room and one or more objects and define fastening structures at section lines such that the pieces may be fastened together following printing. This process is described in greater detail below with respect to FIG. 6.

The design engine 114 may include a printing module 116e. The printing module 116e may interface with a 3D printer to invoke printing of the pieces generated by the sectioning module 116d. The 3D printer may be any 3D printing type or model known in the art.

The server system 102 may access one or more public databases 118 to obtain information such as known dimensions of features identified on a scanned object. The information may be obtained over a network 120 such as the Internet or other type of network connection.

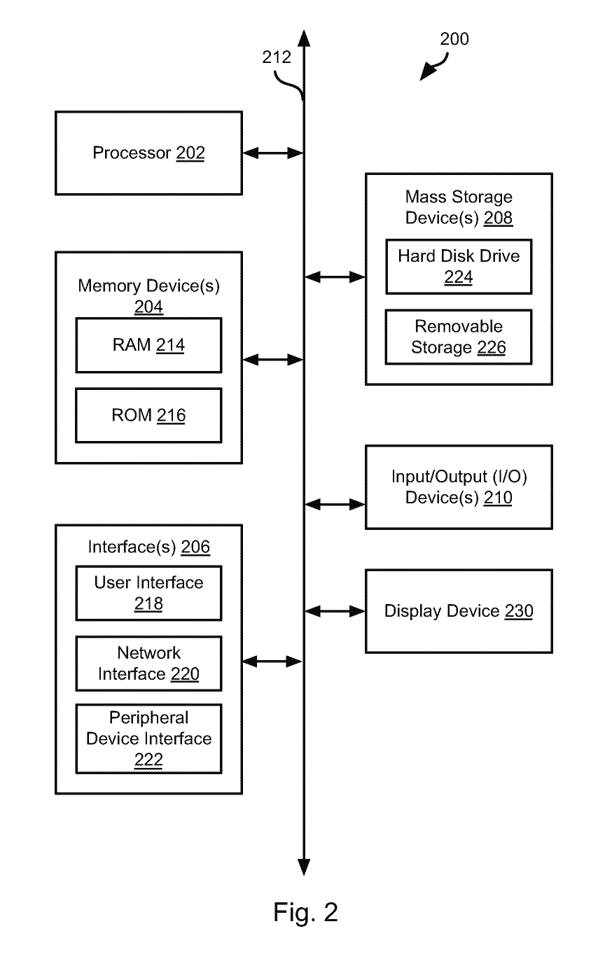

FIG. 2 is a block diagram illustrating an example computing device 200. Computing device 200 may be used to perform various procedures, such as those discussed herein. The server system 102 may have some or all of the attributes of the computing device 200. Computing device 200 can function as a server, a client, or any other computing entity. Computing device can perform various monitoring functions as discussed herein, and can execute one or more application programs, such as the application programs described herein. Computing device 200 can be any of a wide variety of computing devices, such as a desktop computer, a notebook computer, a server computer, a handheld computer, a tablet computer and the like. A server system 102 may include one or more computing devices 200 each including one or more processors.

Computing device 200 includes one or more processor(s) 202, one or more memory device(s) 204, one or more interface(s) 206, one or more mass storage device(s) 208, one or more Input/Output (I/O) device(s) 210, and a display device 230 all of which are coupled to a bus 212. Processor(s) 202 include one or more processors or controllers that execute instructions stored in memory device(s) 204 and/or mass storage device(s) 208. Processor(s) 202 may also include various types of computer-readable media, such as cache memory.

Memory device(s) 204 include various computer-readable media, such as volatile memory (e.g., random access memory (RAM) 214) and/or nonvolatile memory (e.g., read-only memory (ROM) 216). Memory device(s) 204 may also include rewritable ROM, such as Flash memory.

Mass storage device(s) 208 include various computer readable media, such as magnetic tapes, magnetic disks, optical disks, solid-state memory (e.g., Flash memory), and so forth. As shown in FIG. 2, a particular mass storage device is a hard disk drive 224. Various drives may also be included in mass storage device(s) 208 to enable reading from and/or writing to the various computer readable media. Mass storage device(s) 208 include removable media 226 and/or non-removable media.

I/O device(s) 210 include various devices that allow data and/or other information to be input to or retrieved from computing device 200. Example I/O device(s) 210 include cursor control devices, keyboards, keypads, microphones, monitors or other display devices, speakers, printers, network interface cards, modems, lenses, CCDs or other image capture devices, and the like.

Display device 230 includes any type of device capable of displaying information to one or more users of computing device 200. Examples of display device 230 include a monitor, display terminal, video projection device, and the like.

Interface(s) 206 include various interfaces that allow computing device 200 to interact with other systems, devices, or computing environments. Example interface(s) 206 include any number of different network interfaces 220, such as interfaces to local area networks (LANs), wide area networks (WANs), wireless networks, and the Internet. Other interface(s) include user interface 218 and peripheral device interface 222. The interface(s) 206 may also include one or more peripheral interfaces such as interfaces for printers, pointing devices (mice, track pad, etc.), keyboards, and the like.

Bus 212 allows processor(s) 202, memory device(s) 204, interface(s) 206, mass storage device(s) 208, I/O device(s) 210, and display device 230 to communicate with one another, as well as other devices or components coupled to bus 212. Bus 212 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 200, and are executed by processor(s) 202. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

Referring to FIG. 3A, the illustrated method 300 may be executed by a server system 102 in combination with sensors 104 in order to obtain a 3D model of a space. The method 300 may include performing 302 a 3D scan of a space. Performing 302 a 3D scan may include obtaining both a point cloud of measurements of the space as well as images of the space. The point cloud and images may then be combined to obtain a full-color model of the space. In some embodiments, a full color model is obtained exclusively using images rather than using a point cloud from a laser scanner.

The method 300 may include identifying 304 features in the space, including doors, windows, counters, pieces of furniture, and the like. Windows may be identified based on their geometry: a vertical planar surface that is offset horizontally from a surrounding planar surface. Doors may be identified in a similar manner: a rectangular gap in a vertical planar surface. Counters and tables may be identified as horizontal planar surfaces vertically offset above a horizontal planar surface representing a floor. Features may also be identified 304 manually. For example, a user may select a feature and specify what it is (window, table, dresser, etc.).

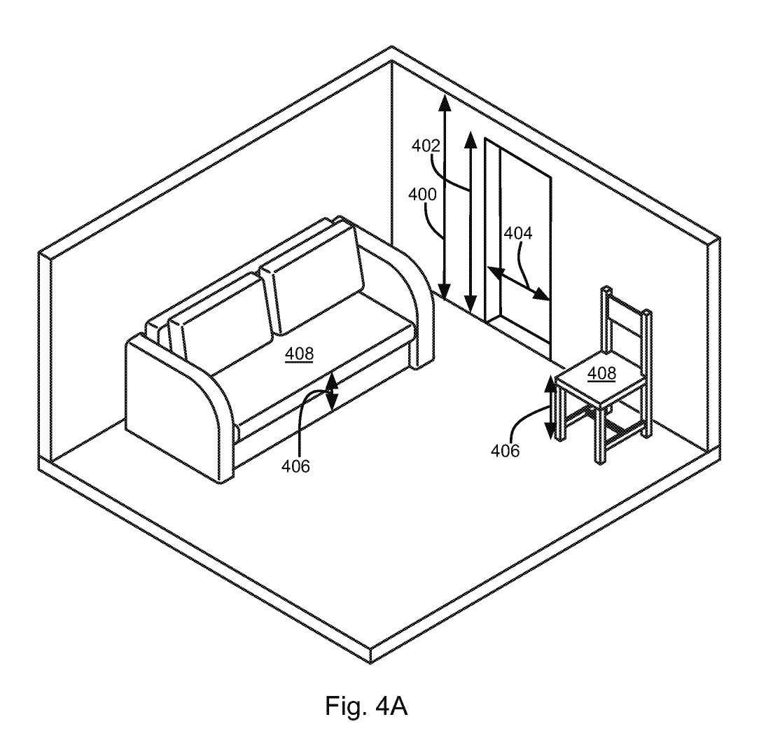

The method 300 may further include identifying 306 at least one reference feature. Referring to FIG. 4A, a reference feature may include a dimension that is identical in most rooms or buildings. For example, the ceiling height 400 of a room in a residence is eight feet. Likewise, the height 402 of a door is usually 6 feet and eight inches. Doors widths 404 are usually one of a set of standard sizes: 30, 32, 34, or 36 inches. The distance 406 from the floor to a seating surface 408 of a couch or chair is also generally within a standard range of values. Accordingly, where one of these features is detectable in a model, the size of the feature in the coordinate space of the model may then be mapped to real dimensions.

The method 300 may include determining 308 the room scale. For example, where a feature identified in step 306 has dimension X in the coordinate space and is known to have a real dimension of Y, and then the scale is Y/X to convert the coordinate space to real space.

Referring to FIG. 3B, a similar process 310 may be performed for other entities such as people, furniture, pets, etc. The method 310 may include performing a 3D scan of the entity, such as using the same or a different scanning device than for step 302 of the method 300. The scanning of step 312 may be performed in a different plate at a different time than the scanning of step 302. For example, a mobile scanner may be taken to a customer's home for step 302 whereas the customer and one or more pets are scanned using a scanning system located in a store. Where the entity being scanned is a person, props and costumes may be worn during scanning.

The method 310 may include identifying 314 reference features of the entity. For example, referring to FIG. 4B, features such as knee height 410 may be related to the height of 406 of seating surfaces. In particular, a distance from the floor to a person's knee may be assumed to be generally equal to, or a some factor of, the height 406 of seating surfaces in that person's home. The entity scale may then be determined 316 according to the size of the reference feature. For example, where a feature identified in step 314 has dimension X in the coordinate space and is known to have a real dimension of Y, then the scale is Y/X to convert the coordinate space to real space. The dimensions of other features of a person that do not vary considerably between individual may be used such as head size 412 or some other measurement.

Referring to FIG. 5, the illustrated method 500 may be executed by the server system 500 in order to generate a combined model of a room that was the subject of the method 300 and an entity that was the subject of the method 310. Entities may also be added to the model of a room that are purely virtual, i.e. a model is defined using computer design tools but is not based on, or not completely based on, scanning of an actual object.

The method 500 may include determining 502 the scale of a room, such as by executing the method 300 of FIG. 3A. The method 500 may include determining 504 the scale of an entity to be added to the model of the room, such as by executing the method 310 of FIG. 3B with respect to one or more entities.

The method 500 may further include scaling 506 one or both of the room and the entity such that the scales match. For example, if the room has a scale of 1.1 and the entity has a scale of 0.9, then the room may be scaled down by multiplying it by (0.9/1.1) or the entity may be scaled up by multiplying it by (1.1/0.9). Alternatively, both may be scaled to have a new scale equal to a common value (e.g. 1.0).

The method 500 may further include generating 508 a combined model. In particular, the entity may be placed resting on a floor of the model of the room or otherwise located in the room. Where the entity is a piece of furniture, the model of the entity may be placed along a wall (e.g. where the furniture is a couch or chair) or at the center of the model of the room (e.g. where the furniture is an area rug or coffee table).

The combined model may then be rendered 510 in a computer display or 3D printed. In some embodiments, prior to 3D printing of the combined model the method 600 of FIG. 6 may be executed in order to divide the combined model into separate pieces that are 3D printed separately.

Referring to FIG. 6, the illustrated method 600 may include identifying 602 section points. Section points may include the corners of the room, a mid point of walls of the room, a junction between items of furniture of the room and the walls or floor of the room, a junction between an entity added to the model of the room and the model of the room. For example, section points may include areas having a thickness above some threshold value such that they may serve as attachment points for fasteners. Section points may be defined at the boundaries between objects detected by an abrupt change in thickness, curvature, or other attribute.

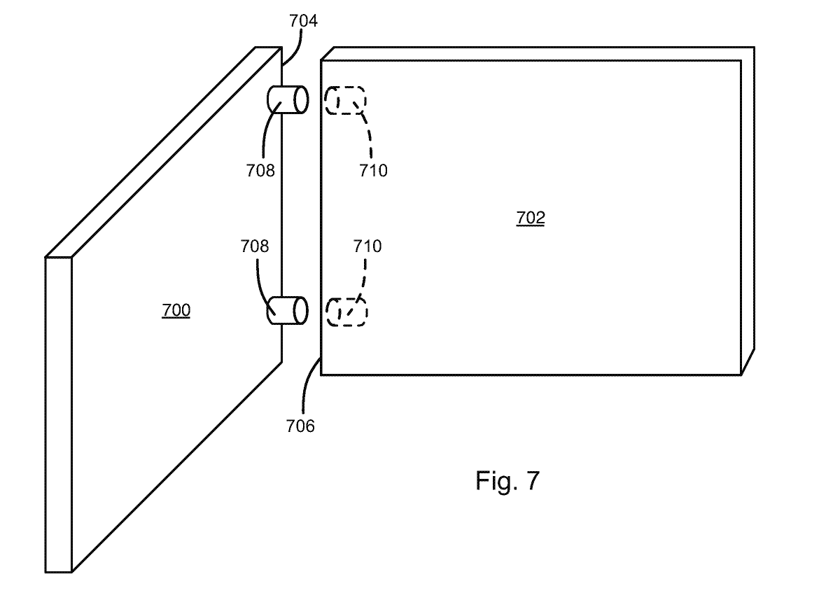

The method 600 may further include dividing 604 the model. This may include defining separate models for the portions of the combined model as divided along the section points of step 602. For each of these separate models, fastening features may be added 606 at the section points. For example, as shown in FIG. 7, wall 700 is sectioned from wall 702 along edges 704, 706. Accordingly, one or more fastening features 708 may be added 606 to edge 704 and one or more corresponding fastening features 710 may be added to edge 706. For example, fastening feature 708 may be a post and fastening feature 710 may be a receptacle sized to receive the post, or vice versa. Any fastening system known in the art may be used to implement the fastening features 708, 710.

In some embodiments, the 3D printed model may be in color. In other embodiments, it is monochromatic. Instructions effective to paint the model to resemble the colors of the model may be output. Likewise, instructions as to what pieces are to be fastened together to assemble the model may be output. For example, in addition to adding fastening features 708, 710 one or more labels indicating edges that are to be coupled to one another may be printed on or near the edges 704, 706.

The pieces as defined at steps 602-606 may then be 3D printed 608 and the separate pieces may be fastened 610 to one another to form a complete model. In some embodiments, electronics may be incorporated into the model. For example, objects such as lamps may have LED lights incorporated therein. Models of electronic devices, such as sound systems, may have sound producing electronics placed therein. Accordingly, the server system 102 may modify the combined model to define cavities within elements of the model that can later be occupied with the electronic devices.

As noted previously, prior to 3D printing, other elements may be added to the combined model from a database, such as models of products, animals, fanciful creatures, or other models of artistic or realistic elements.

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed is:

1. A method comprising:
receiving, by a computer system from a first scanning device, a first scan of an interior space;
receiving, by the computer system from one of the first scanning device and a second scanning device, a second scan of at least one entity, the second scan being performed at a different location than the interior space;
identifying, by the computer system, a first feature in the first scan;
identifying, by the computer system, a second feature in the second scan;
determining, by the computer system, a first scale for the first scan according to a size of the first feature;
determining, by the computer system, a second scale for the second scan according to the size of the first feature; and
generating, by the computer system, a combined model including the first scan and the second scan wherein at least one of the first scan and the second scan is scaled to match the other of the first scan and second scan.

2. The method of claim 1, wherein the first scan of the interior space includes a model comprising both point cloud data and image data detected in the interior space.

3. The method of claim 1, wherein the at least one entity is a person.

4. The method of claim 3, wherein the second feature is a body part of the person.

5. The method of claim 3, wherein the second feature is a leg of the person.

6. The method of claim 1, wherein the at least one entity is an item of furniture.

7. The method of claim 1, wherein the first feature is a floor-to-ceiling distance in the interior space.

8. The method of claim 1, wherein the first feature is a seat height of at least one of a chair or sofa.

9. The method of claim 1, further comprising invoking, by the computer system, three-dimensional printing of the combined model.

10. The method of claim 9, wherein three-dimensionally printing the combined model comprises:
dividing a portion of the combined model corresponding to the first scan into separate pieces;
defining fastening structures on the separate pieces configured to secure the separate pieces to one another; and
three-dimensionally printing the separate pieces.

11. A system comprising:
a first scanning device;
an imaging device;
a computer system coupled to the first scanning device and the imaging device, the computer system including one or more processing devices and one or more memory devices coupled to the one or more processing devices, the one or more memory devices storing executable code effective to cause the one or more processing devices to:
receive from the first scanning device, a first scan of an interior space, the first scan being a three-dimensional scan of the interior space;
receive from one of the first scanning device and a second scanning device, a second scan of at least one entity, the second scan being performed at a different location than the interior space and being a three-dimensional scan of the at least one entity;
identify a first feature in the first scan;
identify a second feature in the second scan;
determine a first scale for the first scan according to a size of the first feature;
determine a second scale for the second scan according to the size of the first feature; and
generate a combined model including the first scan and the second scan wherein at least one of the first scan and the second scan is scaled to match the other of the first scan and second scan.

12. The system of claim 11, wherein the first scan of the interior space includes a model comprising both point cloud data and image data detected in the interior space.

13. The system of claim 11, wherein the at least one entity is a person.

14. The system of claim 11, wherein the second feature is a body part of the person.

15. The system of claim 11, wherein the second feature is a leg of the person.

16. The system of claim 11, wherein the at least one entity is an item of furniture.

17. The system of claim 11, wherein the first feature is a floor-to-ceiling distance in the interior space.

18. The system of claim 11, wherein the first feature is a seat height of at least one of a chair or sofa.

19. The system of claim 11, wherein the executable code is further effective to invoke three-dimensional printing of the combined model.

20. The system of claim 19, wherein the executable code is further effective to invoke three-dimensional printing of the combined model by
dividing a portion of the combined model corresponding to the first scan into separate pieces;
defining fastening structures on the separate pieces configured to secure the separate pieces to one another; and
three-dimensionally printing the separate pieces.
